(19) United States
(12) Patent Application Publication
(10) Pub. No.: US 2009/0080110 A1
(43) Pub. Date: Mar. 26, 2009

(54) PERPENDICULAR RECORDING MAGNETIC MEDIA WITH IMBALANCED MAGNETIC MOMENT MULTILAYER CAP STRUCTURE

(76) Inventors: Andreas Berger, Donostia - San Sebastian (ES); Yoshihiro Ikeda, San Jose, CA (US); Kentaro Takano, San Jose, CA (US)

Correspondence Address: DUFT BORNSEN & FISHMAN, LLP, 1526 SPRUCE STREET, SUITE 302, BOULDER, CO, 80302, US

(21) Appl. No.: 11/860,441

(22) Filed: Sep. 24, 2007

(51) Int. Cl. G11B 5/127

(52) U.S. Cl. 360/125.02

(57) ABSTRACT

A perpendicular magnetic recording media is provided having an imbalanced magnetic moment multilayer cap. The perpendicular magnetic recording media comprises a granular layer, and a multilayer cap structure exchange coupled to the granular layer. The multilayer cap structure includes upper and lower magnetic layers separated by a non-magnetic layer, where the upper magnetic layer has a magnetic moment greater than the lower magnetic layer. When an external field is applied to the recording media, a larger moment torque is triggered at the surface, and more efficient switching is facilitated. The upper magnetic layer may have a higher magnetic moment than the lower magnetic layer if the upper magnetic layer comprises a larger magnetic moment material than the lower magnetic layer. The upper magnetic layer may also have a higher magnetic moment than the lower magnetic layer if the upper magnetic layer has a greater thickness than the lower magnetic layer.

### BACKGROUND OF THE INVENTION

1. Field of the Invention

The invention is related to the field of magnetic recording disk drive systems and, in particular, to a perpendicular recording magnetic media with an imbalanced multilayer cap structure.

2. Statement of the Problem

Magnetic hard disk drive systems typically include a magnetic disk, a recording head having write and read elements, a suspension arm, and an actuator arm. As the magnetic disk is rotated, air adjacent to the disk surface moves with the disk. This allows the recording head (also referred to as a slider) to fly on an extremely thin cushion of air, generally referred to as an air bearing. When the recording head flies on the air bearing, the actuator arm swings the suspension arm to place the recording head over selected circular tracks on the rotating magnetic disk where signal fields are written to and read by the write and read elements, respectively. The write and read elements are connected to processing circuitry that operates according to a computer program to implement write and read functions.

In a disk drive utilizing perpendicular recording, data is recorded on a magnetic recording disk by magnetizing the recording media in a direction perpendicular to the surface of the disk. The recording media typically comprises a substrate, an underlayer on the substrate, a magnetic recording layer on the underlayer and a protective layer over the magnetic recording layer.

Exchange spring (ES) perpendicular media allows for high density recording of up to 1 Tbit/in². In exchange spring media, each magnetic grain of the magnetic recording layer consists of two different materials. One is a hard-magnetic material, which has a very high anisotropy Ku and is thermally stable even for very small grain sizes. By itself, this type of layer requires a very high switching field. Thus, a second layer of the exchange spring media comprises a soft-magnetic material (i.e., has a smaller Ku) magnetically coupled to the hard-magnetic material. Due to the spring effect of the soft layer, the hard layer can be switched with a much smaller switching field without decreasing the thermal stability of the recording media. However, the soft layer requires a relatively large thickness to produce a sufficient magnetic twist.

Multilayer caps solve the problem of using a relatively thick soft layer by providing a cap structure with two or more layers of soft magnetic material separated by non-magnetic material. Typically, these multilayer caps utilize two layers of soft magnetic material which have an identical thickness. These multilayer caps are relatively smaller than a single layer soft magnetic cap, and provide the same magnetic switching. However, the magnetic moment is equally distributed along the cap thickness direction, and therefore, neither the coupling strength between the magnetic layers, nor the magnetic anisotropies in the individual layers of the multilayer cap are optimized for overall recording performance.

### SUMMARY OF THE SOLUTION

Embodiments of the invention solve the above and other related problems with a perpendicular magnetic recording media having a multilayer cap structure with an imbalanced magnetic moment among the magnetic layers of the multilayer cap structure. The perpendicular magnetic recording media comprises a granular layer, and a multilayer cap structure exchange coupled to the granular layer. The multilayer cap structure includes upper and lower magnetic layers separated by a non-magnetic layer, where the upper magnetic layer has a magnetic moment which is greater than the lower magnetic layer. This imbalanced magnetic moment can be accomplished by choosing a first magnetic material for the upper magnetic layer which has a greater magnetic moment than a second magnetic material of the lower magnetic layer. Alternatively, an imbalanced magnetic moment can be created if a thickness of the upper magnetic layer is greater than a thickness of the lower magnetic layer. Because the upper magnetic layer (e.g., the first magnetic layer) has a greater thickness than the lower magnetic layer (e.g., the second magnetic layer), the magnetic moment in the upper magnetic layer is higher and the magnetic anisotrophies are optimized for better recording performance.

The upper magnetic layer also exhibits a lower magneto-crystalline anisotropy, as the strong perpendicular anisotrophy in the magnetic multilayer cap structure is an interface effect, and scales proportionally to the inverse of the magnetic material thicknesses. Therefore, when an external field is applied to the recording media, a larger moment torque is triggered at the surface, and more efficient switching is facilitated. Advantageously, the recording media yields better writability and a higher signal to noise ratio (SNR) for high density recording.

One embodiment of the invention comprises a perpendicular magnetic recording media comprising a granular layer and an interface layer above the granular layer. The perpendicular magnetic recording media further comprises a multilayer cap structure above the interface layer and exchange coupled to the granular layer. The multilayer cap structure comprises a plurality of magnetic layers separated by non-magnetic layers, and an upper magnetic layer of the alternating magnetic layers and non-magnetic layers has a greater magnetic moment than a lower magnetic layer of the alternating magnetic layers and non-magnetic layers.

Another embodiment of the invention comprises a perpendicular magnetic recording media comprising a granular layer and an interface layer above the granular layer. The perpendicular magnetic recording media further comprises a multilayer cap structure above the interface layer and exchange coupled to the granular layer. The multilayer cap structure comprises a plurality of magnetic layers separated by non-magnetic layers, and an upper magnetic layer has a thickness greater than a lower magnetic layer.

Another embodiment of the invention comprises a perpendicular magnetic recording media comprising a substrate, an underlayer on the substrate, a magnetic recording layer and a protective layer. The magnetic recording layer comprises a granular layer on the underlayer, an interface layer on the granular layer, and a multilayer cap structure above the interface layer and exchange coupled to the granular layer. The multilayer cap structure comprises a plurality of magnetic layers separated by non-magnetic layers, with a thickness of an upper magnetic layer of the plurality of alternating magnetic and non-magnetic layers comprising between greater than 50% and about 91% of a total thickness of the upper magnetic layer and a lower magnetic layer of the plurality of alternating magnetic and non-magnetic layers.

The invention may include other exemplary embodiments described below.

### DESCRIPTION OF THE DRAWINGS

The same reference number represents the same element or same type of element on all drawings.

FIG. 1 illustrates a cross-sectional view of a perpendicular magnetic recording media in an exemplary embodiment of the invention.

FIG. 2 illustrates a cross-sectional view of a perpendicular magnetic recording media in another exemplary embodiment of the invention.

FIG. 3 illustrates an implementation of a perpendicular magnetic recording media in an exemplary embodiment of the invention.

FIG. 4 illustrates a graph of M-H (Kerr) loops for various Co thickness ratios for the exemplary embodiment of the invention of FIG. 3.

FIG. 5 illustrates a graph of write head current dependence of the normalized signals for various Co thickness ratios for the exemplary embodiment of the invention of FIG. 3.

FIG. 6 illustrates a graph of the signal to noise dependence on the —Co or CoCr upper layer thickness ratio for the exemplary embodiment of the invention of FIG. 3.

FIG. 7 illustrates a graph of magnetic write width (MWW) dependence on the Co or CoCr upper layer thickness ratio for the exemplary embodiment of the invention of FIG. 3.

FIG. 8 illustrates a flow chart of a method for fabricating a perpendicular magnetic recording media in an exemplary embodiment of the invention.

FIGS. 9-11 illustrate cross sectional views of a perpendicular magnetic recording media during fabrication according to the method of FIG. 8 in exemplary embodiments of the invention.

### DETAILED DESCRIPTION OF THE INVENTION

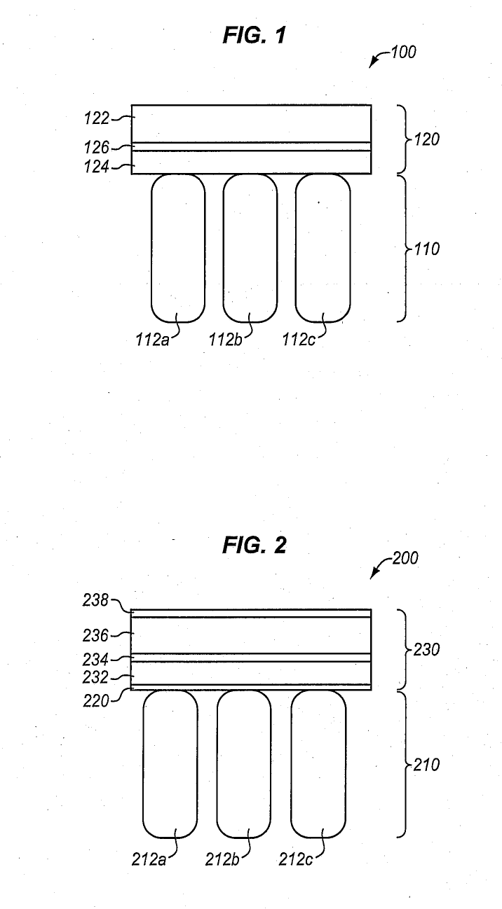

FIGS. 1-11 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a cross-sectional view of a perpendicular magnetic recording media 100 in an exemplary embodiment of the invention. Perpendicular magnetic recording media 100 comprises a granular layer 110. Granular layer 110 comprises a relatively hard magnetic material with well isolated magnetic grains 112a, 112b and 112c. Granular layer 110 may be formed of a Co-Alloy, such as CoPtCr+Oxide, with a strong perpendicular magnetic anisotrophy.

Grains 112a, 112b and 112c of granular layer 110 may be weakly exchange coupled laterally, which leads to low magnetic transition noise. Additional elements may be added to granular layer 110 to provide chemical segregation between individual grains 112a, 112b and 112c, and enhance exchange decoupling.

Perpendicular magnetic recording media 100 further comprises a multilayer cap structure 120 strongly exchanged coupled perpendicularly to granular layer 110. Multilayer cap structure 120 and granular layer 110 may be continuous exchange coupled. Multilayer cap structure 120 is referred to as a “continuous” exchange coupled layer because there is a dense packing of the magnetic grains such that lateral exchange forces are readily transmitted between the grains.

Multilayer cap structure 120 may comprise a plurality of magnetic layers separated by non-magnetic layers, with the magnetic layers having a perpendicular magnetic anisotropy. As illustrated in FIG. 1, multilayer cap structure 120 includes an upper magnetic layer 122 and a lower magnetic layer 124 separated by a non-magnetic layer 126. Upper magnetic layer 122 refers to a magnetic layer of multilayer cap structure 120 which is farthest away from granular layer 110. Upper magnetic layer 122 has a greater magnetic moment than lower magnetic layer 124. As illustrated in FIG. 1, upper magnetic layer 122 has a thickness greater than lower magnetic layer 124. Upper magnetic layer 122 and lower magnetic layer 124 may be continuous layers of Co/Pt, or Co/Pd.

Because upper magnetic layer 122 has a greater thickness than lower magnetic layer 124, the magnetic moment in upper magnetic layer 122 is higher than lower magnetic layer 124. Upper magnetic layer 122 also exhibits a lower magneto-crystalline anisotropy, as the strong perpendicular anisotrophy in multilayer cap structure 120 is an interface effect, and scales proportionally to the inverse of the magnetic material thicknesses. Therefore, when an external field is applied to multilayer cap structure 120, a larger moment torque is triggered at the surface (i.e., near upper magnetic layer 122), and more efficient switching is facilitated. Advantageously, the recording media yields better writability, a higher SNR for high density recording, and improved thermal stability.

Alternatively, a greater magnetic moment may be created in upper magnetic layer 122 than in lower magnetic layer 122 if upper magnetic layer 122 comprises a first magnetic material which has a higher magnetic moment than a second magnetic material 124 that comprises lower magnetic layer 124. For example, the first magnetic material may comprise Co and the second magnetic material may comprise CoCr10 (10 atomic % Cr with the remaining balance being Co). Co has a higher magnetic moment than CoCr10, thus, upper magnetic layer 122 has a higher magnetic moment than lower magnetic layer 124. In this embodiment, the thickness of lower magnetic layer 122 may be substantially the same as upper magnetic layer 124, or may be different depending on desired design criteria.

FIG. 2 illustrates a cross-sectional view of a perpendicular magnetic recording media 200 in another exemplary embodiment of the invention. Perpendicular magnetic recording media 200 comprises a granular layer 210. Granular layer 210 may be similar to granular layer 110 of FIG. 1, and comprises a relatively hard magnetic material with well isolated magnetic grains 212a, 212b and 212c. Granular layer 210 may be formed of CoCr with a strong perpendicular magnetic anisotrophy.

Perpendicular magnetic recording media 200 further comprises a continuous multilayer cap structure 230 exchanged coupled perpendicularly to granular layer 210 at an interface layer 220. Multilayer cap structure 230 and granular layer 210 may be continuous exchange coupled. Interface layer 220 may be used to enhance the growth of multilayer cap structure 230 and to moderate the strength of the exchange coupling between granular layer 210 and multilayer cap structure 230. If perpendicular magnetic recording media 200 is to be used in a rigid disk drive that uses a pole type write head, a soft magnetically permeable underlayer (not shown) may be located on the disk substrate beneath granular layer 210.

Multilayer cap structure 230 comprises a plurality of magnetic layers separated by non-magnetic layers. More specifically, multilayer cap structure 230 comprises a lower magnetic layer 232 above interface layer 220, a first non-magnetic layer 234 above lower magnetic layer 232, an upper magnetic layer 236 above first non-magnetic layer 234, and a second non-magnetic layer 238 above upper magnetic layer 236. Upper magnetic layer 236 has a thickness greater than lower magnetic layer 232. Upper magnetic layer 236 and lower magnetic layer 232 may be continuous layers of Co/Pt, or Co/Pd. Non-magnetic layers 234 and 238 may be Pt or Pd, depending on whether magnetic layers 232 and 236 are Co/Pt or Co/Pd, respectively.

Likewise, interface layer 220 may be Pt or Pd (i.e., the same material as non-magnetic layers 234 and 238), depending on whether magnetic layers 232 and 236 are Co/Pt or Co/Pd, respectively. A thickness of interface layer 220 may be less than a thickness of non-magnetic layers 234 and 238 to allow adequate exchange coupling of multilayer cap structure 230 and granular layer 210. Like perpendicular magnetic recording media 100 of FIG. 1, perpendicular magnetic recording media 200 has more efficient switching, which yields better writability, a higher SNR and improved thermal stability.

The material composition of granular layer 210 (see FIG. 2) or granular layer 110 (see FIG. 1) can comprise Co, CoCr(0.1 atomic %-40 atomic %), CoCr(0.1 atomic %-40 atomic %)Pt(0.1 atomic %-30 atomic %), or CoCrPt (comprising the same composition range as CoCrPt)+oxide such as SiOx, TaOx, TiOx, NbOx, BOx etc. (0.1 mol %-10 mol %), CoCrPt(comprising the same composition range as CoCrPt)+B(0.1 atomic %-20 atomic %), or any combination of these compositions.

Interface layer 220 (See FIG. 2), first non-magnetic layer 234, second non-magnetic layer 238 and non-magnetic layer 126 (see FIG. 1) may comprise substantially the same material compositions. For example, these layers may comprise Pt, Pd, Ta, Ru, Cr or their alloys, or some weakly magnetic RuCo(0.1 atomic %-80 atomic %), CoCr(30 atomic %-99.9 atomic %), RuCo(0.1 atomic %-80 atomic %)Cr(0.1 atomic %-80 atomic %) or their alloys.

Lower magnetic layer 232 and upper magnetic layer 236, as well as upper magnetic layer 122 (see FIG. 1) and a lower magnetic layer 124 may have material compositions comprising Co, CoCr(0.1 atomic %-30 atomic %), CoCr(0.1 atomic %-40 atomic %)Pt(0.1 atomic %-30 atomic %), and CoCrPt(comprising the same composition range as CoCrPt)+oxide such as SiOx, TaOx, TiOx, NbOx, BOx, etc. (0.1 mol %-10 mol %), CoCrPt(comprising the same composition range as CoCrPt)+B(0.1 atomic %-20 atomic %), or combination of these. The material composition of lower magnetic layer 232 and upper magnetic layer 236 may be the same if each layer has a different thickness and a different magnetic moment. Alternatively, the thickness of lower magnetic layer 232 and upper magnetic layer 236 can be different to provide varying magnetic moments in the layers.

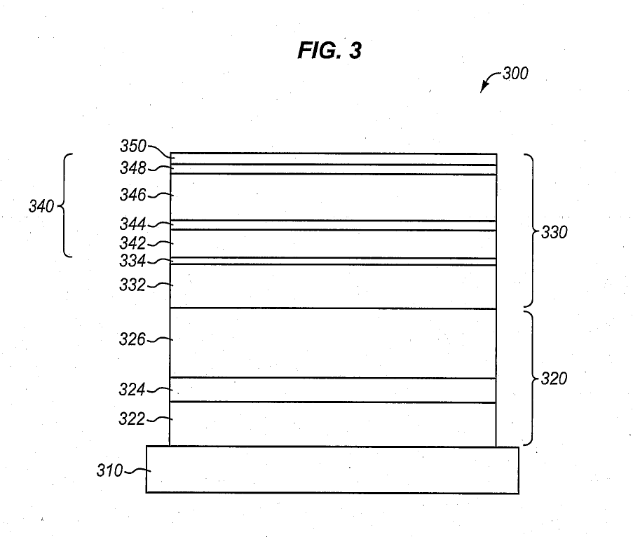

FIG. 3 illustrates an implementation of a perpendicular magnetic recording media 300 in an exemplary embodiment of the invention. The implementation of perpendicular magnetic recording media 300 was tested to measure the effect of the imbalanced multilayer cap structure. Perpendicular magnetic recording media 300 comprises a substrate 310, such as glass. Perpendicular magnetic recording media 300 further comprises an underlayer 320. In the illustrated embodiment, underlayer 320 comprises a soft underlayer 322 for returning headflux, which is comprised of 30 nm of CoFeTaZr. Underlayer 320 further comprises an orientation layer 324, which is comprised of 8 nm of NiW6, and a growth enhancing layer or seed layer 326, which is comprised of 15 nm of graded Ar pressure Ru.

Perpendicular magnetic recording media 300 also comprises a magnetic recording layer 330, comprising a granular layer 332 (e.g., a hard magnetic material), which is comprised of 13 nm of CoPt18Cr17-SiOx8 (18 atomic % Pt, 17 atomic %, Cr, 8 molar % SiOx with the remaining balance comprising Co (about 65 atomic %)). Magnetic recording layer 330 also comprises an interface layer 334, which is comprised of 0.5 nm of Pt, and a multilayer cap structure 340. Multilayer cap structure 340 comprises a lower magnetic layer 342, which is Co or CoCr11, a layer of non-magnetic material 344, which is comprised of 1 nm of Pt, an upper magnetic layer 346, which is Co or CoCr11, and a second layer of non-magnetic material 348, which is comprised of 1 nm of Pt. Perpendicular magnetic recording media 300 also comprises a protective layer 350, which is comprised of 3 nm of SiNx.

The total thickness of multilayer cap structure 340 was held constant at 3.5 nm, and the thickness of lower magnetic layer 342 and upper magnetic layer 346 were varied to measure the effect of a change in the ratio between the thickness of lower magnetic layer 342 and upper magnetic layer 346. The thickness of lower magnetic layer 342 was varied between 0.5 nm and 0 nm, while the thickness of upper magnetic layer 346 was varied between 0.5 nm and 0.9 nm. By keeping the total thickness of multilayer cap structure 340 constant, the thickness ratio of the upper Co layer (e.g., upper magnetic layer 346) to the total Co layer thickness (e.g., upper magnetic layer 346 and lower magnetic layer 342) was changed from 50% (5 A/5 A) to 100% (10 A/0 A).

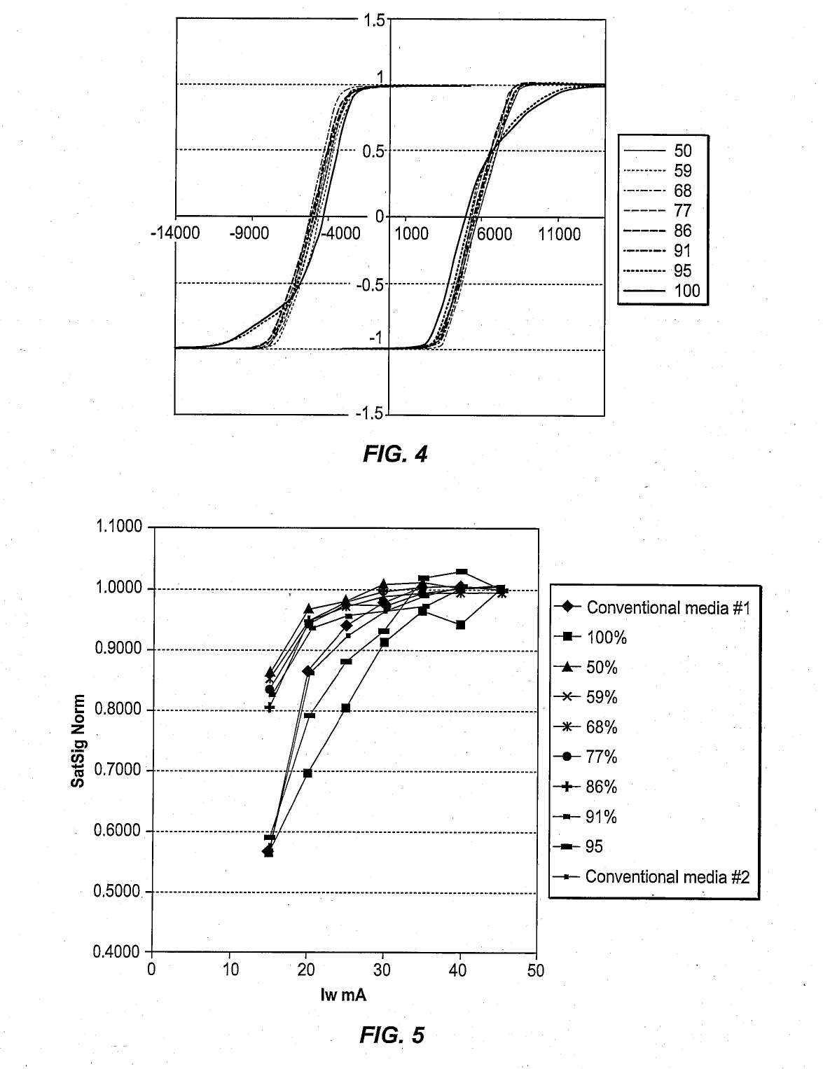

FIG. 4 illustrates a graph of several M-H (Kerr) loops for various Co thickness ratios for the exemplary embodiment of the invention of FIG. 3. When the thickness ratio of the upper Co magnetic layer to the total Co layer thickness was changed from 50% to 91%, no significant changes were observed, but when the ratio is larger than 91%, the loops show long tails towards the loop closing point. This indicates that the thin lower layer in this region can no longer sufficiently support the magnetic coupling between the top Co layer (e.g., multilayer cap structure 340) and the bottom granular layer (e.g., granular layer 332).

FIG. 5 illustrates a graph of write head current dependence of the normalized signals of various Co thickness ratios for the exemplary embodiment of the invention in FIG. 3. When the thickness ratio of the upper Co layer to the total Co layer thickness was changed from 50% to 91%, the media is very easy to saturate and shows better writability than conventional media (e.g., Conventional Media #1 and Conventional Media #2 (see FIG. 5)). For 95% to 100% top Co-layer ratios, the films show much poorer write performance, consistent with the Kerr loop observations.

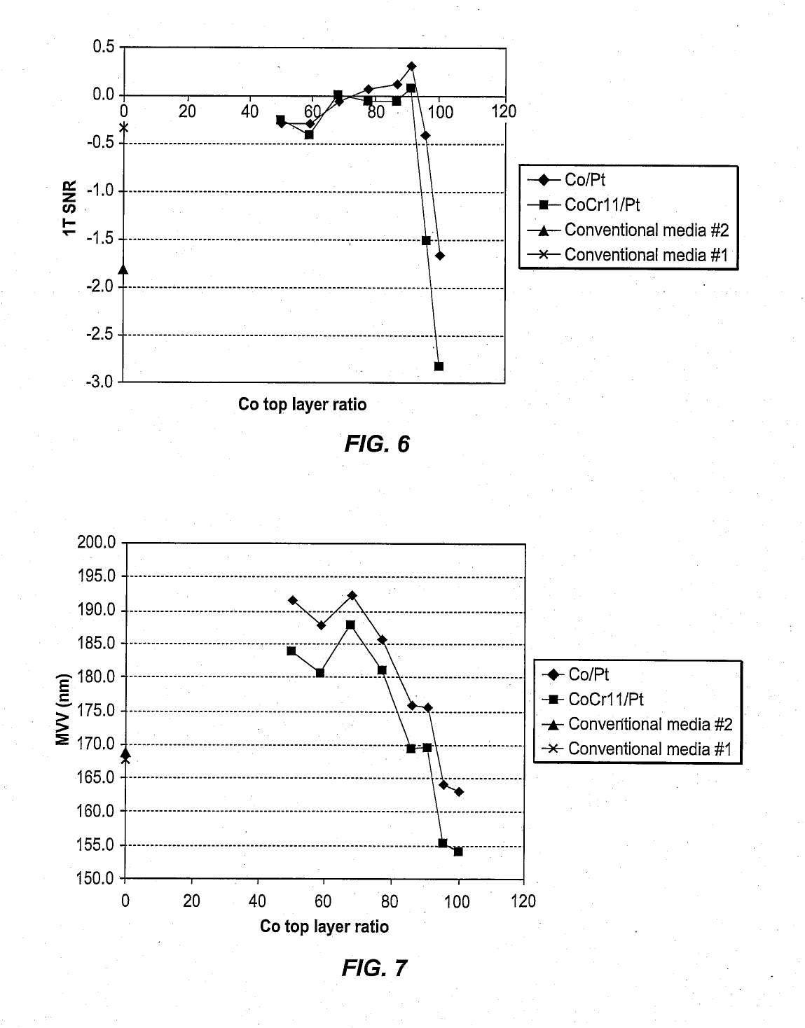

FIG. 6 illustrates a graph of the SNR dependence on the Co or CoCr upper layer thickness ratio of the exemplary embodiment of the invention in FIG. 3. Starting from a 50% ratio of the upper CoCr layer 346 to the total thickness of the Co layers of multilayer cap structure 340, the SNR increases with an increased layer thickness ratio which shows a maximum at a 91% ratio, and then drops significantly. This drop is mainly due to the writability issue described above. In this study of the exemplary embodiment of FIG. 3, the media SNR was increased 0.5-0.7 dB by shifting the magnetic moment in multilayer cap structure 340 from lower magnetic layer 342 to upper magnetic layer 346.

FIG. 7 illustrates a graph of magnetic write width (MWW) dependence on the Co or CoCr upper layer thickness ratio of the exemplary embodiment of the invention in FIG. 3. The MWW is continuously decreasing with an increasing upper Co or CoCr layer ratio. The narrower MWW indicates the potential for achieving higher track densities. As the writability data illustrates, even with a narrower MWW, the writability is still very good at up to a 91% ratio. Thus, both the SNR and MWW are improved without any degradation of the writability.

Thus, a thickness of upper magnetic layer 346 (see FIG. 3) may be between 50% and about 91% of a total thickness of upper magnetic layer 346 and lower magnetic layer 342 for the most efficient utilization of perpendicular magnetic recording media 300. For example, a ratio between upper magnetic layer 346 and lower magnetic layer 342 may be about 9 to 1 for optimized write performance. Thus, for the embodiment described in FIG. 3, a thickness of upper magnetic layer 346 may vary between about 0.5 nm to about 0.9 nm, while a thickness of lower magnetic layer 342 may vary between 0.1 nm to 0.5 nm. In the exemplary perpendicular magnetic recording media 300 illustrated in FIG. 3, since the total thickness of multilayer cap structure 340 is 3.5 nm, then a 9 to 1 ratio corresponds to an upper magnetic layer 346 thickness of 0.9 nm, and a lower magnetic layer 342 thickness of 0.1 nm.

Those of ordinary skill in the art will recognize that the layers and thicknesses of perpendicular magnetic recording media 300 (see FIG. 3) are exemplary, and may be changed based on selected design criteria. Further, there is no requirement for keeping the total Co-layer thickness in multilayer cap structure 340 constant. This was done for the purpose of allowing a simple media comparison. One would optimize the individual Co or CoCr layer separately with the condition of having a thicker (and/or higher moment and/or lower anisotrophy) layer on top for the best recording performance. Further, a multilayer cap structure 340 may be utilized with more than two magnetic layers, the upper magnetic layer(s) having a greater thickness than the lower magnetic layers.

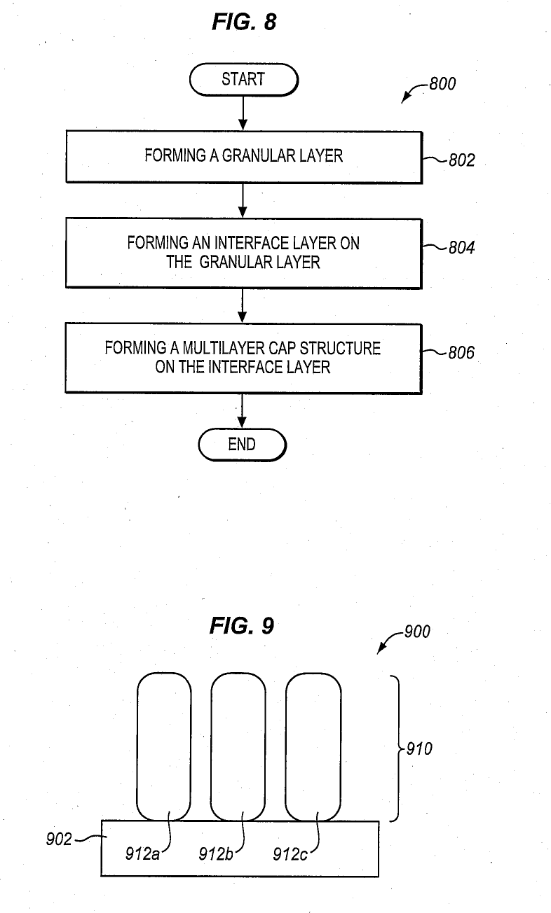

FIG. 8 illustrates a flow chart of a method 800 for fabricating a perpendicular magnetic recording media in an exemplary embodiment of the invention. FIGS. 9-11 illustrate cross sectional views of perpendicular magnetic recording media 900 during fabrication according to method 800 of FIG. 8 in exemplary embodiments of the invention, and the steps of method 800 are described in reference to perpendicular magnetic recording media 900 of FIGS. 9-11. The steps of method 800 may not be all-inclusive, and may include other steps not shown for the sake of brevity.

Step 802 comprises forming a granular layer 910 (see FIG. 9). Granular layer 910 may be formed using standard sputtering techniques. As described above in reference to granular layer 110 of FIG. 1, granular layer 910 may comprise a relatively hard magnetic material with well isolated magnetic grains 912a, 912b and 912c. Additional elements may be added to granular layer 910 to provide chemical segregation between individual magnetic grains 912a, 912b and 912c and enhance exchange decoupling. Granular layer 910 may be formed of CoCr with a strong perpendicular magnetic anisotrophy. Granular layer 910 may be formed over a substrate 902, such as glass, or over an underlayer (not shown). Optionally, the method may comprise forming the underlayer. The underlayer may comprise one or more layers, such as a seed layer (e.g., seed layer 326 of FIG. 3), an orientation layer (e.g., orientation layer 324 of FIG. 3), and/or a soft underlayer for returning head flux (e.g., soft underlayer 322 of FIG. 3). FIG. 9 illustrates perpendicular magnetic recording media 900 after completion of step 802.

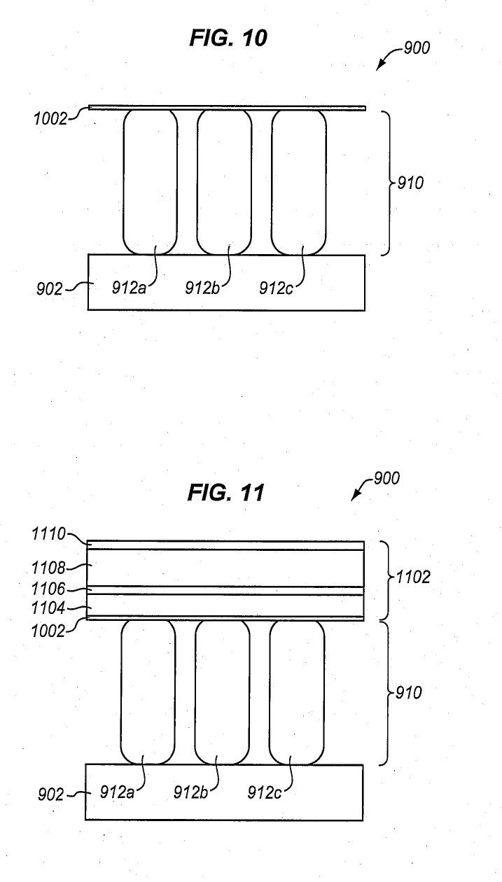

Step 804 comprises forming an interface layer 1002 (see FIG. 10) over granular layer 910. Interface layer 1002 may be formed using standard sputtering techniques. Interface layer 1002 may be a continuous layer of Pt or Pd, depending on whether subsequently formed magnetic layers of a multilayer cap structure cap are Co/Pt or Co/Pd, respectively. FIG. 9 illustrates perpendicular magnetic recording media 900 after completion of step 804.

Step 806 comprises forming a multilayer cap structure 1102 (see FIG. 11) on interface layer 1002. Multilayer cap structure 1102 is exchange coupled to granular layer 910, and includes a plurality of alternating magnetic layers (e.g., lower magnetic layer 1104 and upper magnetic layer 1108) and non-magnetic layers (e.g., non-magnetic layers 1106 and 1110). As described above, upper magnetic layer 1108 has a thickness greater than lower magnetic layer 1104. The layers of multilayer cap structure 1102 may be formed using standard sputtering techniques. FIG. 11 illustrates perpendicular magnetic recording media 900 after completion of step 802. Optionally, the method may comprise forming a protective layer (not shown), such as protective layer 350 of FIG. 3.

Although specific embodiments were described herein, the scope of the invention is not limited to those specific embodiments. The scope of the invention is defined by the following claims and any equivalents thereof.

We claim:

1. A perpendicular magnetic recording media comprising:
a granular layer; and
a multilayer cap structure exchange coupled to the granular layer, the multilayer cap structure including first and second magnetic layers separated by a non-magnetic layer, the first magnetic layer being above the second magnetic layer and having a magnetic moment greater than the second magnetic layer.

2. The perpendicular magnetic recording media of claim 1, wherein the first magnetic layer has a thickness greater than the second magnetic layer.

3. The perpendicular magnetic recording media of claim 2, wherein the thickness of the first magnetic layer comprises between about 50% and about 91% of a total thickness of the first and second magnetic layers.

4. The perpendicular magnetic recording media of claim 2, wherein a ratio between the thickness of the first magnetic layer and a thickness of the second magnetic layer is about 9 to 1.

5. The perpendicular recording media of claim 2, wherein the thickness of the first magnetic layer is between about 0.5 nm to about 0.9 nm, and a thickness of the second magnetic layer is between about 0.1 nm to about 0.5 nm.

6. The perpendicular magnetic recording media of claim 2, wherein the multilayer cap structure further comprises:
a first non-magnetic layer; and
a second non-magnetic layer,
wherein the first magnetic layer is disposed between the first and second non-magnetic layers, and the second magnetic layer is disposed between the second magnetic layer and non-magnetic layer.

7. The perpendicular magnetic recording media of claim 1, wherein the first magnetic layer comprises a first magnetic material and the second magnetic layer comprises a second magnetic material, with the magnetic moment of the first magnetic material being greater than the magnetic moment of the second magnetic material.

8. A perpendicular magnetic recording media comprising:
a granular layer;
an interface layer above the granular layer; and
a multilayer cap structure above the interface layer and exchange coupled to the granular layer, the multilayer cap structure comprising a plurality of magnetic layers separated by non-magnetic layers,
wherein an upper magnetic layer of the plurality of magnetic layers separated by non-magnetic layers has a magnetic moment greater than at least one lower magnetic layer of the plurality of magnetic layers separated by non-magnetic layers.

9. The perpendicular magnetic recording media of claim 8, wherein the upper magnetic layer of the plurality of magnetic layers separated by non-magnetic layers comprises a first magnetic material and the at least one lower magnetic layer of the plurality of magnetic layers separated by non-magnetic layers comprises a second magnetic material, with the magnetic moment of the first magnetic material being greater than the magnetic moment of the second magnetic material.

10. The perpendicular magnetic record media of claim 8, wherein the upper magnetic layer of the plurality of magnetic layers separated by non-magnetic layers has a thickness greater than the at least one lower magnetic layer of the plurality of magnetic layers separated by non-magnetic layers.

11. The perpendicular magnetic recording media of claim 10, wherein the thickness of the upper magnetic layer comprises between about 50% and about 91% of a total thickness of the upper magnetic layer and lower magnetic layer.

12. The perpendicular magnetic recording media of claim 10, wherein the thickness of the upper magnetic layer is between about 0.5 nm to about 0.9 nm, and the thickness of the at least one lower magnetic layer is between about 0.1 nm to about 0.5 nm.

13. The perpendicular magnetic recording media of claim 10, wherein the interface layer and the non-magnetic layers of the plurality of magnetic layers separated by non-magnetic layers comprise the same material.

14. The perpendicular magnetic recording media of claim 10, wherein a thickness of the interface layer is less than a thickness of each of the non-magnetic layers of plurality of magnetic layers separated by non-magnetic layers.

15. A perpendicular magnetic recording media comprising:
a substrate;
an underlayer on the substrate;
a magnetic recording layer comprising:
a granular layer on the underlayer;
an interface layer on the granular layer; and
a multilayer cap structure above the interface layer and exchange
coupled to the granular layer, the multilayer cap structure comprising a plurality of magnetic layers separated by non-magnetic layers; and
a protective layer above the multilayer cap structure,
wherein a thickness of an upper magnetic layer of the plurality of magnetic layers separated by non-magnetic layers comprises between about 50% and about 91% of a total thickness of the upper magnetic layer and a lower magnetic layer of the plurality of magnetic layers separated by non-magnetic layers.

16. The perpendicular magnetic recording media of claim 15, wherein a ratio between the thickness of the upper magnetic layer and a thickness of the lower magnetic layer is about 9 to 1.

17. The perpendicular magnetic recording media of claim 15, wherein the thickness of the upper magnetic layer is between about 0.5 nm to about 0.9 nm, and a thickness of the lower magnetic layer is between about 0.1 nm to about 0.5 nm.

18. A method for fabricating a perpendicular magnetic recording media, the method comprising:
forming a granular layer;
forming an interface layer on the granular layer; and
forming a multilayer cap structure on the interface layer, the multilayer cap structure exchange coupled to the granular layer and including a plurality of magnetic layers separated by non-magnetic layers,
wherein an upper magnetic layer of the plurality of magnetic layers separated by non-magnetic layers has a magnetic moment greater than a lower magnetic layer of the plurality of magnetic layers separated by non-magnetic layers.

19. The method of claim 18, wherein the upper magnetic layer of the plurality of magnetic layers separated by non-magnetic layers has a thickness greater than a thickness of the lower magnetic layer of the plurality of magnetic layers separated by non-magnetic layers.

20. The method of claim 19, wherein the thickness of the upper magnetic layer comprises between about 50% and about 91% of a total thickness of the upper magnetic layer and lower magnetic layer.

21. The method of claim 19, wherein a ratio between the thickness of the upper magnetic layer and the thickness of the lower magnetic layer is about 9 to 1.

22. The method of claim 19, wherein the thickness of the upper magnetic layer is between about 0.5 nm to about 0.9 nm, and a thickness of the lower magnetic layer is between about 0.1 nm to about 0.5 nm.

23. The method of claim 19, wherein the upper magnetic layer of the plurality of magnetic layers separated by non-magnetic layers comprises a first magnetic material and the lower magnetic layer of the plurality of magnetic layers separated by non-magnetic layers comprises a second magnetic material, with the magnetic moment of the first magnetic material being greater than the magnetic moment of the second magnetic material.

24. The method of claim 18, wherein a thickness of the interface layer is less than a thickness of the non-magnetic layers of the plurality of magnetic layers separated by non-magnetic layers.
